(19) United States
(12) Patent Application Publication
(10) Pub. No.: US 2023/0325841 A1
(43) Pub. Date: Oct. 12, 2023

(54) SYSTEMS AND METHODS FOR DETECTING WEBSITES THAT PERPETRATE AT LEAST ONE OF SCAMS OR FRAUDS

(71) Applicant: GEN DIGITAL INC., Tempe, AZ (US)

(72) Inventors: Iskander Sanchez Rola, Antibes (FR); Kevin Alejandro Roundy, Culver City, CA (US); Platon Kotzias, Athens (GR); Emory Shing-Kuo Shyong, Mountain View, CA (US); Goutham Kumar Nekkalapu, Mountain View, CA (US); Magesh Varadharajan, Mountain View, CA (US)

(21) Appl. No.: 17/660,750

(22) Filed: Apr. 26, 2022

(30) Foreign Application Priority Data
Apr. 7, 2022 (EP) EP22386018.0

(51) Int. Cl. G06Q 20/40; G06Q 30/00

(52) U.S. Cl. CPC G06Q 20/4016; G06Q 30/0185

(57) ABSTRACT

The disclosed computer-implemented method for detecting websites that perpetrate at least one of scams or frauds may include correlating online interaction data with financial transaction data. The online interaction data may include information on suspicious websites obtained through an online interaction analysis, and the financial transaction data may include sources of suspicious financial activity obtained through a transaction trend analysis. The method may additionally include detecting at least one of online scams or frauds based on the correlation. The detection may include detecting that an online interaction is suspicious based on correlation thereof to a suspicious financial transaction, and/or detecting that a financial transaction is suspicious based on correlation thereof to a suspicious online interaction. The method may also include performing a security action in response to the detection. Various other methods, systems, and computer-readable media are also disclosed.

### CROSS-REFERENCE TO RELATED APPLICATION

This application claims priority to European patent application no. EP22386018.0, which was filed on Apr. 7, 2022, and titled “SYSTEMS AND METHODS FOR DETECTING WEBSITES THAT PERPETRATE AT LEAST ONE OF SCAMS OR FRAUDS,” and the entirety of this application is incorporated herein.

### BACKGROUND

If users want to protect their personal economy from online scams or frauds, they do not have many options. They either trust their banks in stopping these unwanted situations, or they pay for third-party extensions or browsers to stop those unwanted websites on access. Each of these solutions uniquely relies on a single datapoint to take decisions: either transaction data or web information. Thus, financial fraud detectors driven by banks do not have the benefit of examining the website in question, whereas websites do not have access to historical financial data, consumer-driven fraud reports, or baselines of normal financial behavior. The present disclosure, therefore, identifies and addresses a need for systems and methods for detecting websites that perpetrate at least one of scams or frauds.

### SUMMARY

As will be described in greater detail below, the present disclosure describes various systems and methods for detecting websites that perpetrate at least one of scams or frauds.

In one example, a method for detecting websites that perpetrate at least one of scams or frauds may include correlating, by the at least one processor, online interaction data with financial transaction data, wherein the online interaction data includes information on suspicious websites obtained through an online interaction analysis, and the financial transaction data includes sources of suspicious financial activity obtained through a transaction trend analysis. The method may additionally include detecting, by the at least one processor, at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction. The method may also include performing, by the at least one processor, a security action in response to the detection.

In some implementations of the method, the correlating may include identifying financial transactions that occur in a same timeframe as online interactions and matching monetary amounts thereof. In some of these implementations, occurring in the same timeframe may correspond to occurring on a same day and/or occurring in a sequence exhibited by both the financial transactions and the online interactions.

In some implementations of the method, the online interaction analysis may include logging one or more websites visited by a user. The online interaction analysis may additionally include differentiating between one or more websites directly accessed by the user and one or more websites accessed due to an online interaction performed by the user. The online interaction analysis may also include logging the online interaction and an online location of the user when the online interaction occurred. The online interaction analysis may further include analyzing when the user inserts payment information, including storing another online location at which the insertion occurred, a monetary amount thereof, and one or more requests generated by the insertion. The online interaction analysis may further include storing information about one or more domains involved in the insertion of payment information and one or more online interactions leading thereto.

In some implementations of the method, the information about one or more domains may include one or more domain reputations. In such implementations, the method may further include triggering the transaction trend analysis in response to detection of a domain having a reputation indicating that the domain is known to be associated with online scams or frauds.

In some implementations, the transaction trend analysis may include identifying one or more confirmed fraud alerts triggered by one or more financial transactions. The transaction trend analysis may additionally include identifying reversed charges that appear in the one or more financial transactions. The transaction trend analysis may also include identifying anomalous behavior exhibited by the one or more financial transactions. The transaction trend analysis may further include determining a merchant reputation score by aggregating the financial transaction data by merchant and analyzing a prevalence of financial transactions thereof that at least one of are reversed, result in confirmed fraud alerts, or exhibit the anomalous behavior.

In some implementations of the method, the method may include triggering the online interaction analysis in response to determination of a merchant reputation score falling below a predetermined threshold.

In some implementations of the method, performing the security action may include improving a blacklist of suspicious websites. Alternative or additional implementations of the method may perform the security action at least in part by improving a suspicion score associated with a website. Alternative or additional implementations of the method may perform the security action at least in part by generating an alert regarding at least one of the suspicious online transaction or a suspicious website associated therewith. Alternative or additional implementations of the method may perform the security action at least in part by blocking access to a suspicious website.

In one embodiment, a system for detecting websites that perpetrate at least one of scams or frauds may include at least one physical processor and physical memory that includes computer-executable instructions that, when executed by the physical processor, cause the physical processor to correlate online interaction data with financial transaction data, wherein the online interaction data includes information on suspicious websites obtained through an online interaction analysis, and the financial transaction data includes sources of suspicious financial activity obtained through a transaction trend analysis. The computer-executable instructions may additionally cause the physical processor to detect at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction. The computer-executable instructions may also cause the physical processor to perform a security action in response to the detection.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to correlate online interaction data with financial transaction data, wherein the online interaction data includes information on suspicious websites obtained through an online interaction analysis, and the financial transaction data includes sources of suspicious financial activity obtained through a transaction trend analysis. The computer-executable instructions may additionally cause the computing device to detect at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction. The computer-executable instructions may also cause the computing device to perform a security action in response to the detection.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for detecting websites that perpetrate at least one of scams or frauds.

FIG. 2 is a block diagram of an additional example system for detecting websites that perpetrate at least one of scams or frauds.

FIG. 3 is a flow diagram of an example method for detecting websites that perpetrate at least one of scams or frauds.

FIG. 4 is a flow diagram of an example method for performing an online interaction analysis in a manner that facilitates the example method for detecting websites that perpetrate at least one of scams or frauds.

FIG. 5 is a flow diagram of an example method for performing a transaction trend analysis in a manner that facilitates the example method for detecting websites that perpetrate at least one of scams or frauds.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for detecting websites that perpetrate at least one of scams or frauds. As will be explained in greater detail below, by correlating online interaction data with financial transaction data, detecting online scams and/or frauds based on the correlation, and performing a security action in response to the detection, the systems and methods described herein may be able to identify one or more sources of fraud reported by customers of financial services (e.g., banks, credit card companies, identity theft protection companies, etc.), and blacklist malicious sites and web content before customers submit payment.

In addition, the systems and methods described herein may improve the functioning of a computing device by performing online interaction monitoring, transaction data analysis, and detection through the propagation of suspicion from sites to transactions and vice versa. This approach may execute dynamically while the user is browsing (e.g., using a browser extension), and/or on the server side using previously logged data.

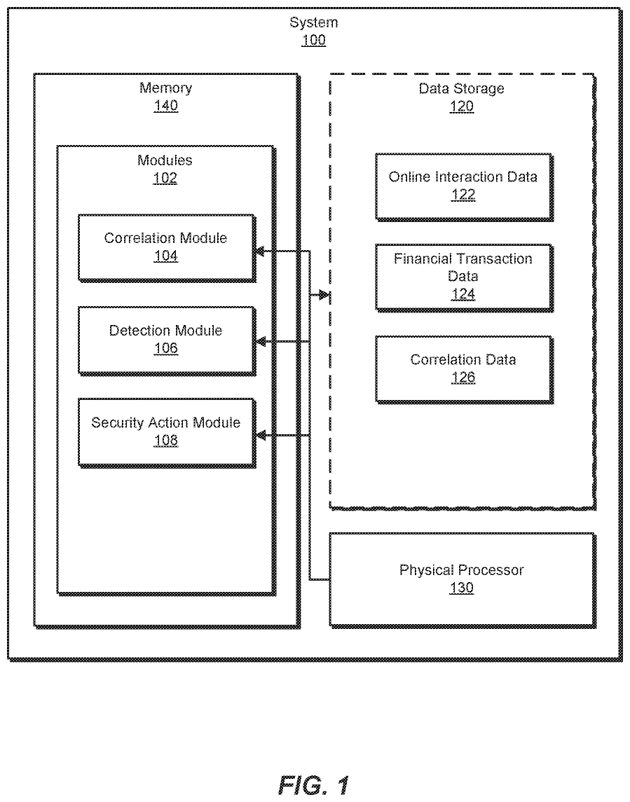

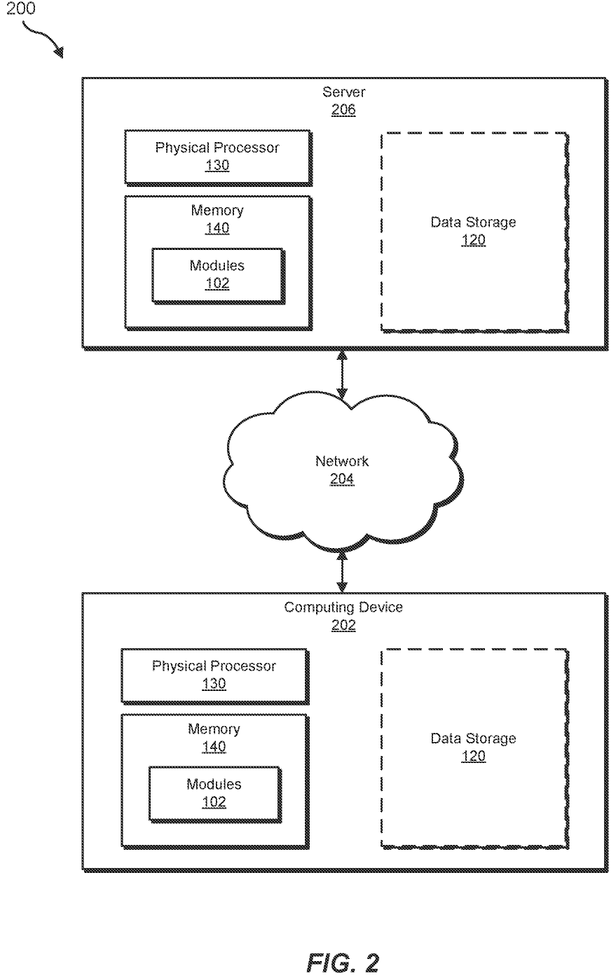

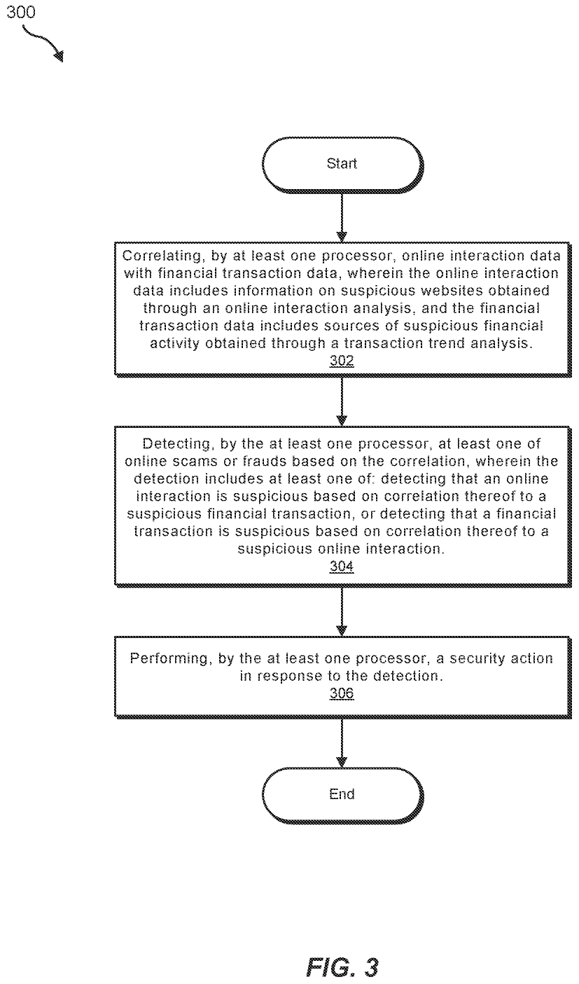

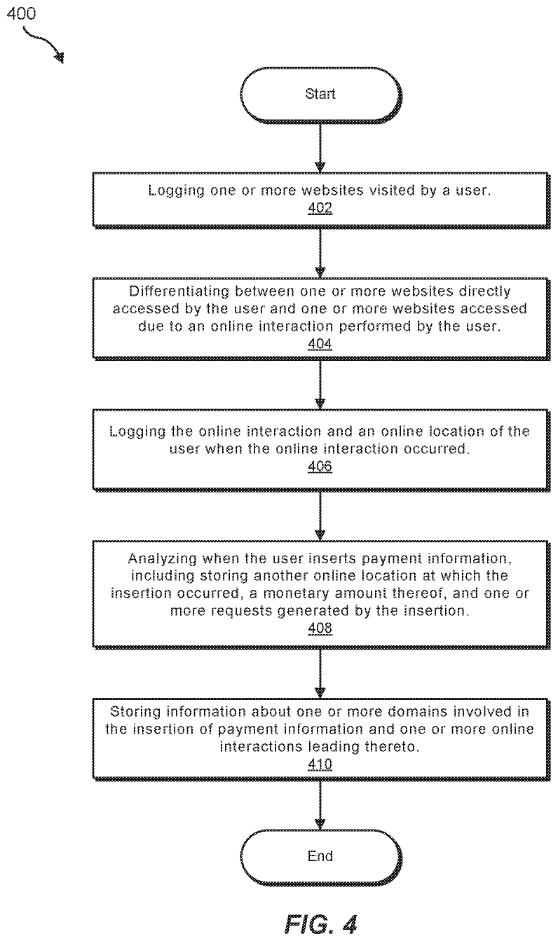

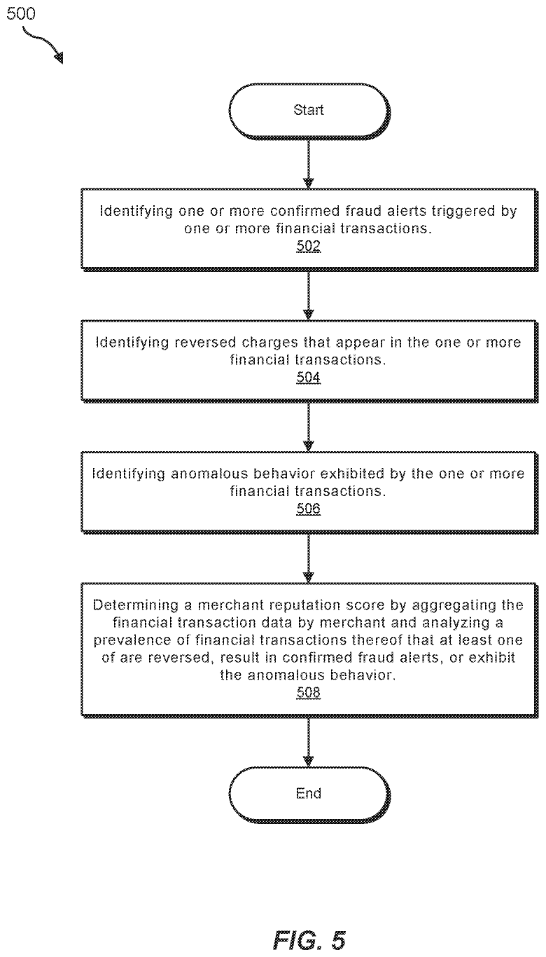

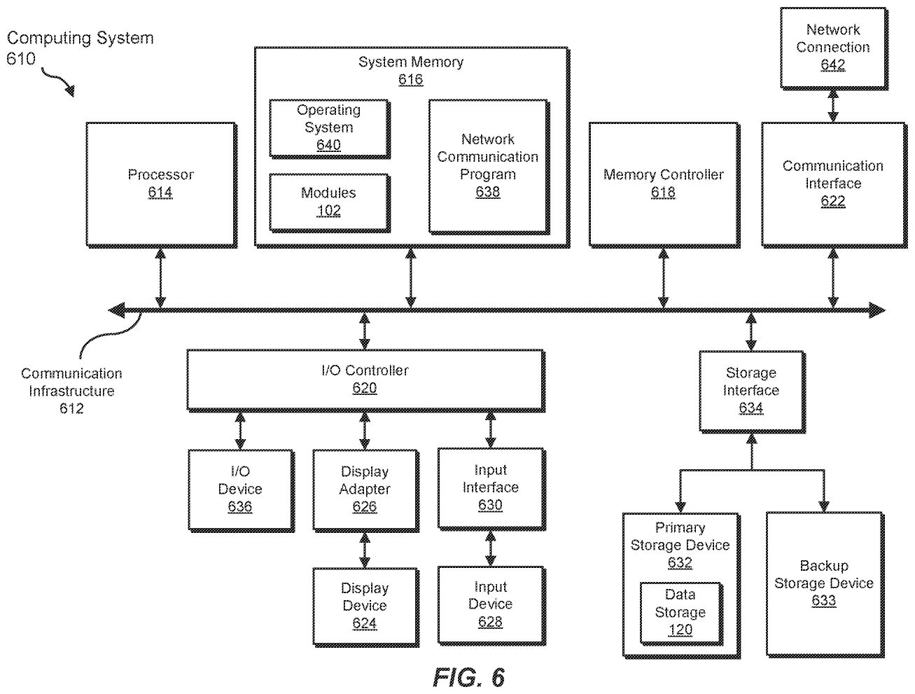

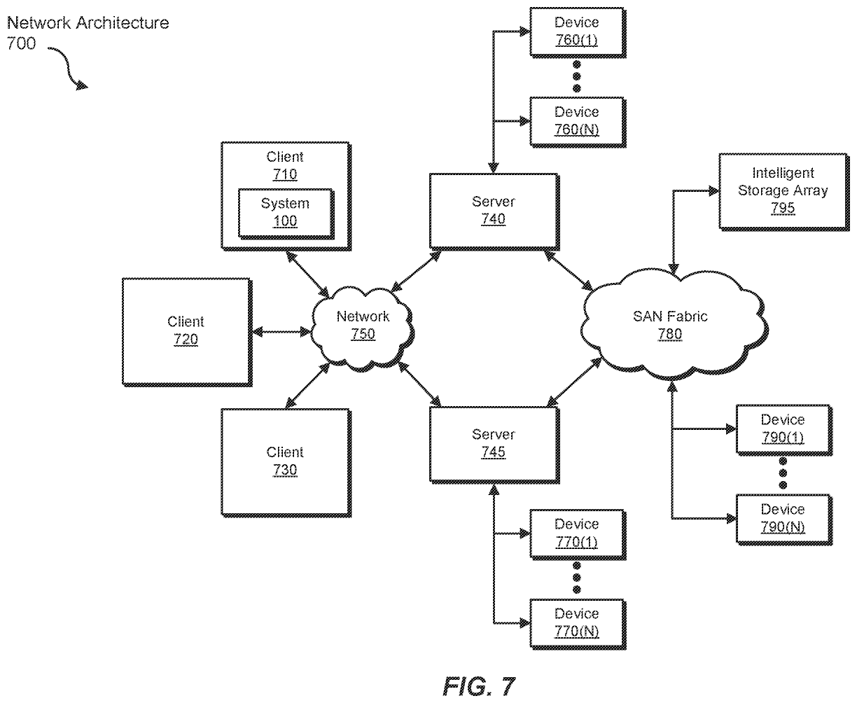

The following will provide, with reference to FIGS. 1-2, detailed descriptions of example systems for detecting websites that perpetrate at least one of scams or frauds. Detailed descriptions of corresponding computer-implemented methods will also be provided in connection with FIG. 3. Detailed descriptions of online interaction and transaction trend analyses are provided with reference to FIGS. 4 and 5, respectively. In addition, detailed descriptions of an example computing system and network architecture capable of implementing one or more of the embodiments described herein will be provided in connection with FIGS. 6 and 7, respectively.

FIG. 1 is a block diagram of an example system 100 for detecting websites that perpetrate at least one of scams or frauds. As illustrated in this figure, example system 100 may include one or more modules 102 for performing one or more tasks. As will be explained in greater detail below, modules 102 may include a correlation module 104, a detection module 106, and a security action module 108. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate detecting websites that perpetrate at least one of scams or frauds. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include one or more instances of stored data, such as data storage 120. Data storage 120 generally represents any type or form of stored data. In one example, data storage 120 may include databases, spreadsheets, tables, lists, matrices, trees, or any other type of data structure. Examples of data storage 120 include, without limitation, online interaction data 122, financial transaction data 124, and/or correlation data 126.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202, server 206, and/or any other suitable computing system. As will be described in greater detail below, one or more of modules 102 from FIG. 1 may, when executed by at least one processor of computing device 202 and/or server 206, enable computing device 202 and/or server 206 to detect websites that perpetrate at least one of scams or frauds. For example, and as will be described in greater detail below, one or more of modules 102 may cause computing device 202 and/or server 206 to correlate online interaction data with financial transaction data, wherein the online interaction data includes information on suspicious websites obtained through an online interaction analysis, and the financial transaction data includes sources of suspicious financial activity obtained through a transaction trend analysis. Additionally, one or more of modules 102 may cause computing device 202 and/or server 206 to detect at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction. Also, one or more of modules 102 may cause computing device 202 and/or server 206 to perform a security action in response to the detection.

Computing device 202 generally represents any type or form of computing device capable of reading computer-executable instructions. For example, computing device may be any computer that employs web browsing functionality. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of interfacing with computing device 202. For example, server 206 may be a reputation server that services reputation lookups. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for detecting websites that perpetrate at least one of scams or frauds. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may correlate, by the at least one processor, online interaction data with financial transaction data, wherein the online interaction data includes information on suspicious websites obtained through an online interaction analysis, and the financial transaction data includes sources of suspicious financial activity obtained through a transaction trend analysis. For example, correlation module 104 may, as part of computing device 202 and/or server 206 in FIG. 2, produce correlation data 126 based on online interaction data 122 and financial transaction data 124.

The term “correlate,” as used herein, generally refers to presenting or setting forth so as to show relationship. For example, and without limitation, one or more pointers may be instantiated between data objects that represent different things, such as online interactions and financial transactions. Alternatively or additionally, data objects representing the different things may be stored in a data structure in such a manner so as to indicate the relationship. In another example, one or more of the data objects representing the two different things may be labeled so as to indicate the relationship.

The term “online interaction data,” as used herein, generally refers to information about an online transaction. For example, and without limitation, online interaction data may include domains at which financial transactions are attempted or made, domains linked to those domains, website data associated with the domains, merchant information provided at the websites, etc.

The term “financial transaction data,” as used herein, generally refers to information about a financial transaction that has been processed by a financial institution. For example, and without limitation, financial transaction data may include transactions pulled from bank accounts and/or credit card statements. Such data may be provided by a service, such as Yodlee, Perfios, Akoya, Flinks, Plaid, Yapily, etc.

The term “suspicious financial activity,” as used herein, generally refers to a fraudulent agreement, or communication, between a buyer and seller to exchange goods, services, or assets for payment. For example, and without limitation, suspicious financial activity may include confirmed incidents of fraudulent transactions, reversed charges, anomalous behavior, etc.

Correlation module 104 may perform the correlation in a variety of ways. For example, modification module 104 may perform the correlating by identifying financial transactions that occur in a same timeframe as online interactions and matching monetary amounts thereof. In some of these implementations, occurring in the same timeframe may correspond to occurring on a same day and/or occurring in a sequence exhibited by both the financial transactions and the online interactions. In additional or alternative implementations, the financial transactions may have time stamps and correlation module 104 may match timestamps of the financial transactions to timestamps of the online interactions. The matching may take into account delay of communication, differences in time zones, etc. Thus, in some cases an online interaction occurring on one day in one time zone may be matched to a corresponding financial transaction reported on a different day in another time zone across a date line. Thus the matching may utilize a recognizable sequence of transactions and online interactions within temporal parameters that may dynamically adjust to allow for potential delay in communications and potential differences in time zones.

At step 304, one or more of the systems described herein may detect, by the at least one processor, at least one of online scams or frauds based on the correlation. For example, detection module 106 may, as part of computing device 202 and/or server 206 in FIG. 2, detect that an online interaction is suspicious based on correlation thereof to a suspicious financial transaction. Alternatively or additionally, detection module 106 may, as part of computing device 202 and/or server 206 in FIG. 2, detect that a financial transaction is suspicious based on correlation thereof to a suspicious online interaction.

Detection module 106 may perform the detection in a variety of ways. For example, detection module 106 may detect that an online transaction is suspicious based on correlation thereof to a financial transaction with a merchant having a reputation score below a predetermined threshold. Alternatively or additionally, detection module 106 may detect that an online transaction is suspicious based on correlation thereof to a financial transaction that triggered a confirmed fraud alert. Alternatively or additionally, detection module 106 may detect that an online transaction is suspicious based on correlation thereof to a financial transaction for which charges are reversed. Alternatively or additionally, detection module 106 may detect that an online transaction is suspicious based on correlation thereof to a financial transaction exhibiting anomalous behavior.

At step 304, one or more of the systems described herein may perform, by the at least one processor, a security action in response to the detection. For example, security action module 108 may, as part of computing device 202 and/or server 206 in FIG. 2, perform one or more security actions.

Security action module 108 may perform the security action in a variety of ways. For example, security action module 108 may improve a blacklist of suspicious websites. Alternatively or additionally, security action module 108 may improve (e.g., make more accurate) a suspicion score associated with a website. Alternatively or additionally, security action module 108 may generate an alert regarding at least one of the suspicious online transaction or a suspicious website associated therewith. Alternatively or additionally, security action module 108 may block access to a suspicious website.

As illustrated in FIG. 4, a method 400 for performing an online interaction analysis may facilitate the method 300 for detecting websites that perpetrate at least one of scams or frauds. For example, the online interaction analysis may, at step 402, log one or more websites visited by a user and, at step 404, differentiate between websites directly accessed by the user and websites accessed due to an online interaction performed by the user. At step 406, the online interaction analysis may log an online interaction and an online location of the user when the online interaction occurred. At step 408, the online interaction analysis may analyze when the user inserts payment information, including storing another online location at which the insertion occurred, a monetary amount thereof, and one or more requests generated by the insertion. At step 410, the online interaction analysis may store information about one or more domains involved in the insertion of payment information and one or more online interactions leading thereto.

In some implementations of the method 400, the information about one or more domains may include one or more domain reputations. In such implementations, the method 400 may further include triggering the transaction trend analysis in response to detection of a domain having a reputation indicating that the domain is known to be associated with online scams or frauds. For example, information about the online interaction with the poorly reputed domain may be transmitted to a reputation server configured to perform the transaction trend analysis. By performing an updated transaction trend analysis in response to this trigger, the server may correlate the online interaction with a financial transaction and identify a merchant associated therewith. If this merchant is not previously known to be associated with the suspicious domain, then the triggered transaction trend analysis can result in a rapid detection that the merchant is suspicious. The determination that the merchant is suspicious may be imputed to other domains known to be associated with the merchant, and this information may be propagated to other computing devices for use in preventing online interactions with those domains and/or alerting users of risk when interacting with those domains.

As illustrated in FIG. 5, a method 500 for performing a transaction trend facilitates the method 300 for detecting websites that perpetrate at least one of scams or frauds. For example, the transaction trend analysis may, at step 502, identify one or more confirmed fraud alerts triggered by one or more financial transactions. At step 504, the transaction trend analysis may identify reversed charges that appear in the one or more financial transactions. At step 506, the transaction trend analysis may identify anomalous behavior exhibited by the one or more financial transactions. At step 508, the transaction trend analysis may determine a merchant reputation score by aggregating the financial transaction data by merchant and analyzing a prevalence of financial transactions thereof that at least one of are reversed, result in confirmed fraud alerts, or exhibit the anomalous behavior.

In some implementations of the method 500, the method 500 may include triggering the online interaction analysis in response to determination of a merchant reputation score falling below a predetermined threshold. For example, information about a merchant reputation that falls below the threshold may be transmitted to a reputation server configured to perform the online interaction analysis. By performing an updated online interaction analysis in response to this trigger, the server may correlate the financial transaction with an online interaction and identify a domain associated therewith. If this domain is not previously known to be associated with the suspicious merchant, then the triggered online interaction analysis can result in a rapid detection that the domain is suspicious. The determination that the domain is suspicious may be imputed to other domains known to be associated with the domain, and this information may be propagated to computing devices for use in preventing online interactions with those domains and/or alerting users of risk when interacting with those domains.

The foregoing disclosure details systems and methods that leverage different sources of information to make the most informed decision in each case. By combining information collected about which websites users access, how they interact with them (e.g., if they insert payment information) and the corresponding transactions that occur, detection of malicious websites and suspicious transactions may be greatly improved, resulting in improved security and fraud prevention for customers. Even when identity and/or fraud protection services provide financial transaction fraud warnings after a transaction is completed and reported by a bank via a service for aggregating financial transaction data (e.g., YODLEE), the disclosed systems and methods are able to identify sources of fraud reported by customers and blacklist malicious sites and web content before customer submit payment. As detailed above, the disclosed systems and methods are based on three different components: online interaction monitoring, transaction data analysis, and detection through the propagation of suspicion from sites to transactions and vice versa. This approach can happen dynamically while the user is browsing (e.g., using a browser extension), or on the server side using already logged data.

A disclosed online interaction analysis may use a browser extension to log all the websites that the user is visiting and differentiate between websites directly accessed by the user (e.g., writing the URL in the address bar), and the ones that happened due to an interaction performed by the user (e.g., clicking a link on a website). In the specific case of the user interaction, the analysis may also log the action performed and where the user was when it happened. For example, the analysis may log that the user clicked <a> with “href=example.com” in “shop.com”. In order to better understand which websites may be responsible for the corresponding transactions that may later happen, the analysis may analyze when users insert payment information (e.g., validating with a JavaScript library, such as “Creditcard.js”), and store where it happened, an amount, and requests generated. The analysis may further store information about the different domains that were involved in the processes previously described (e.g., WHOIS data and domain reputation). If any of the domains is known to be associated with scams, the analysis may trigger a transaction trend analysis. Vice versa, the transaction trend analysis may also trigger online interaction analysis investigations.

A disclosed transaction trend analysis may treat fraud alerts as a key source of suspicious transaction trends when those fraud alerts are generated by an identity theft protection service and are subsequently confirmed as instances of fraud by customers. Such alerts may be triggered by unusually large or high-frequency transactions. Additionally, the analysis may identify reversed charges that appear in a customer's financial transactions as a probable sign of customer dissatisfaction. In many cases, these reversed charges are implicit declarations by the user that the merchant with whom they conducted business is not reputable. If a substantial fraction of all transactions associated with a merchant are reversed, the analysis may determine that the merchant is not reputable. The analysis may also check for additional signs of anomalous behavior on transactions. For example, the analysis may compare the category of the merchant of the transaction and the website that triggered the payment. Alternatively or additionally, the analysis may check if the payment in that specific category diverts from previous transactions of that same user (e.g., amount, time, location, etc.) by performing a statistical analysis (e.g., moving average). Finally, the analysis may produce an evaluation of a merchant involved in a transaction (e.g., reputation, transaction types, etc.). For example, the analysis may aggregate all transaction data by merchant and analyze the prevalence and/or percentage of all transactions with that customer that are reversed or confirmed fraud alerts and use these to establish a reputation score for the merchant.

The disclosed correlation process may correlate web transaction data with financial transaction data. This correlation enables connecting suspicious website visits (identified by the online interaction analysis) to financial anomalies. The process may correlate the data by identifying transactions that happen in the same timeframe as website visits for which it is possible to cross-reference domain and merchant information, and match amounts.

The disclosed detection process may use the correlated website and financial data to more completely and certainly detect online scams than may be achieved without correlated data. For example, consider the following scenarios of online interactions matched to financial transactions:
1: Visit to scam.com (suspect) matching Fraudster Inc. (suspect);
2: Visit to scam.com (suspect) matching Incognito Inc. (unknown); and
3: Visit to rare.com (unknown) matching Fraudster Inc. (suspect).

In Scenario 1, the coinciding visit to the suspect domain and suspect merchant confirm that both the merchant and the domain are highly likely to be malicious, particularly if they coincide regularly. In Scenario 2, suspicion of the suspect domain casts suspicion on the financial transaction, and vice versa in Scenario 3. These scenarios are a non-limiting example, and other scenarios may consider that transactions can be considered suspect for various reasons previously described herein. Suspicion can flow from online interactions to financial transactions and vice versa.

Advantageously, the disclosed systems and methods produce improved blacklist and suspicion scoring, which provide opportunities to cross check the data in new and interesting ways. Even when financial transaction data is not received in real-time, the disclosed systems and methods enable an identity protection service to receive real-time notifications of website visits and warn users in time to avoid scams and fraudulent transactions. The correlation of the data is also beneficial because it enables identity protection services to detect suspect financial activity that originated after a visit to a malicious website as a probable explanation for subsequent financial anomalies. To avoid spamming a user with an excess of uncertain alerts, the systems and methods described herein may set thresholds based on a predetermined maximum number of alerts to generate per user.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, data storage 120 from FIG. 1 may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the present disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for detecting websites that perpetrate at least one of scams or frauds.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive online interaction data and transaction trend data to be transformed, transform the data to generate a correlation output a result of the transformation to detect scams and/or frauds, use the result of the transformation to perform a security action, and store the result of the transformation to improve reputation scores and/or blacklists. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for detecting websites that perpetrate at least one of scams or frauds, at least a portion of the method being performed by a computing device comprising at least one processor, the method comprising:
correlating, by the at least one processor, online interaction data with financial transaction data, wherein the online interaction data includes information on suspicious websites obtained through an online interaction analysis, and the financial transaction data includes sources of suspicious financial activity obtained through a transaction trend analysis;
detecting, by the at least one processor, at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction; and
performing, by the at least one processor, a security action in response to the detection.

2. The method of claim 1, wherein the correlating includes identifying financial transactions that occur in a same timeframe as online interactions and matching monetary amounts thereof.

3. The method of claim 1, wherein occurring in the same timeframe corresponds to at least one of:
occurring on a same day; or
occurring in a sequence exhibited by both the financial transactions and the online interactions.

4. The method of claim 1, wherein the online interaction analysis includes:
logging one or more websites visited by a user;
differentiating between one or more websites directly accessed by the user and one or more websites accessed due to an online interaction performed by the user;
logging the online interaction and an online location of the user when the online interaction occurred;
analyzing when the user inserts payment information, including storing another online location at which the insertion occurred, a monetary amount thereof, and one or more requests generated by the insertion; and
storing information about one or more domains involved in insertion of payment information and one or more online interactions leading thereto.

5. The method of claim 1, wherein the information about one or more domains includes one or more domain reputations, the method further comprising:
triggering the transaction trend analysis in response to detection of a domain having a reputation indicating that the domain is known to be associated with online scams or frauds.

6. The method of claim 1, wherein the transaction trend analysis includes:
identifying one or more confirmed fraud alerts triggered by one or more financial transactions;
identifying reversed charges that appear in the one or more financial transactions;
identifying anomalous behavior exhibited by the one or more financial transactions; and
determining a merchant reputation score by aggregating the financial transaction data by merchant and analyzing a prevalence of financial transactions thereof that at least one of are reversed, result in confirmed fraud alerts, or exhibit the anomalous behavior.

7. The method of claim 6, further comprising:
triggering the online interaction analysis in response to determination of a merchant reputation score falling below a predetermined threshold.

8. The method of claim 1, wherein performing the security action includes at least one of:
improving a blacklist of suspicious websites;
improving a suspicion score associated with a website;
generating an alert regarding at least one of a suspicious online transaction or a suspicious website associated therewith; or
blocking access to a suspicious website.

9. A system for detecting websites that perpetrate at least one of scams or frauds, the system comprising:
at least one physical processor;
physical memory comprising computer-executable instructions that, when executed by the physical processor, cause the physical processor to:
correlate online interaction data with financial transaction data, wherein the online interaction data includes information on suspicious websites obtained through an online interaction analysis, and the financial transaction data includes sources of suspicious financial activity obtained through a transaction trend analysis;
detect at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction; and
perform a security action in response to the detection.

10. The system of claim 9, wherein the correlating includes identifying financial transactions that occur in a same timeframe as online interactions and matching monetary amounts thereof.

11. The system of claim 9, wherein occurring in the same timeframe corresponds to at least one of:
occurring on a same day; or
occurring in a sequence exhibited by both the financial transactions and the online interactions.

12. The system of claim 9, wherein the online interaction analysis includes:
logging one or more websites visited by a user;
differentiating between one or more websites directly accessed by the user and one or more websites accessed due to an online interaction performed by the user;
logging the online interaction and an online location of the user when the online interaction occurred;
analyzing when the user inserts payment information, including storing another online location at which the insertion occurred, a monetary amount thereof, and one or more requests generated by the insertion; and
storing information about one or more domains involved in insertion of payment information and one or more online interactions leading thereto.

13. The system of claim 9, wherein the information about one or more domains includes one or more domain reputations, and the computer-executable instructions further cause the physical processor to:
trigger the transaction trend analysis in response to detection of a domain having a reputation indicating that the domain is known to be associated with online scams or frauds.

14. The system of claim 9, wherein the transaction trend analysis includes:
identifying one or more confirmed fraud alerts triggered by one or more financial transactions;
identifying reversed charges that appear in the one or more financial transactions;
identifying anomalous behavior exhibited by the one or more financial transactions; and
determining a merchant reputation score by aggregating the financial transaction data by merchant and analyzing a prevalence of financial transactions thereof that at least one of are reversed, result in confirmed fraud alerts, or exhibit the anomalous behavior.

15. The system of claim 14, wherein the computer-executable instructions further cause the physical processor to:
trigger the online interaction analysis in response to determination of a merchant reputation score falling below a predetermined threshold.

16. The system of claim 9, wherein the computer-executable instructions cause the physical processor to perform the security action by at least one of:
improving a blacklist of suspicious websites;
improving a suspicion score associated with a website;
generating an alert regarding at least one of a suspicious online transaction or a suspicious website associated therewith; or
blocking access to a suspicious website.

17. A non-transitory computer-readable medium comprising one or more computer-executable instructions that, when executed by at least one processor of a computing device, cause the computing device to:
correlate online interaction data with financial transaction data, wherein the online interaction data includes information on suspicious websites obtained through an online interaction analysis, and the financial transaction data includes sources of suspicious financial activity obtained through a transaction trend analysis;
detect at least one of online scams or frauds based on the correlation, wherein the detection includes at least one of: detecting that an online interaction is suspicious based on correlation thereof to a suspicious financial transaction, or detecting that a financial transaction is suspicious based on correlation thereof to a suspicious online interaction; and
perform a security action in response to the detection.

18. The non-transitory computer-readable medium of claim 17, wherein the online interaction analysis includes:
logging one or more websites visited by a user;
differentiating between one or more websites directly accessed by the user and one or more websites accessed due to an online interaction performed by the user;
logging the online interaction and an online location of the user when the online interaction occurred;
analyzing when the user inserts payment information, including storing another online location at which the insertion occurred, a monetary amount thereof, and one or more requests generated by the insertion; and
storing information about one or more domains involved in insertion of payment information and one or more online interactions leading thereto.

19. The non-transitory computer-readable medium of claim 17, wherein the transaction trend analysis includes:
identifying one or more confirmed fraud alerts triggered by one or more financial transactions;
identifying reversed charges that appear in the one or more financial transactions;
identifying anomalous behavior exhibited by the one or more financial transactions; and
determining a merchant reputation score by aggregating the financial transaction data by merchant and analyzing a prevalence of financial transactions thereof that at least one of are reversed, result in confirmed fraud alerts, or exhibit the anomalous behavior.

20. The non-transitory computer-readable medium of claim 17, wherein the computer-executable instructions cause the computing device to perform the security action by at least one of:
improving a blacklist of suspicious websites;
improving a suspicion score associated with a website;
generating an alert regarding at least one of a suspicious online transaction or a suspicious website associated therewith; or
blocking access to a suspicious website.
